(19) United States
(12) Patent Application Publication
(10) Pub. No.: US 2010/0297944 A1
(43) Pub. Date: Nov. 25, 2010

(54) MULTI-DEVICE CONTROL METHOD AND APPARATUS FOR COMMUNICATION DEVICES

(75) Inventor: Jong Rim LEE, Seoul (KR)

Correspondence Address: THE FARRELL LAW FIRM, LLP, 290 Broadhollow Road, Suite 210E, Melville, NY, 11747, US

(73) Assignee: Samsung Elecrtonics Co., Ltd., Gyeonggi-do (KR)

(21) Appl. No.: 12/786,985

(22) Filed: May 25, 2010

(30) Foreign Application Priority Data
May 25, 2009 (KR) 10-2009-0045414

(51) Int. Cl. H04B 7/00

(52) U.S. Cl. 455/41.2

(57) ABSTRACT

A multi-device control method and a related apparatus are provided for transmission of information between communication devices. In the method, a master device shares particular information with a serving device after accessing the serving device through a communication channel, including a human body. Then the master device measures signal strength of each of slave devices using the communication channel. The slave devices include the serving device. The master device selects one of the slave devices as a target device with relatively greater signal strength, and then transmits the information to the target device through the communication channel.

### PRIORITY

This application claims priority under 35 U.S.C. §119(a) to a Korean Patent Application filed in the Korean Intellectual Property Office on May 25, 2009, and assigned Serial No. 10-2009-0045414, the entire disclosure of which is incorporated herein by reference.

### BACKGROUND OF THE INVENTION

1. Field of the Invention

The present invention relates generally to a communication method and apparatus and, more particularly, to a multi-device control method and apparatus for transmission of information between communication devices.

2. Description of the Related Art

Communication systems are currently evolving toward providing high-speed, large-capacity multimedia service such as a data service as well as offering traditional voice service. In such a communication system, a number of communication devices often share information. Namely, a communication device can transmit particular information to any eligible communication device deployed in the same communication system after accessing that device. Here, a communication device can individually select a desired device among other devices, depending on a user's manipulation. In addition, a communication device accesses other respective devices one after another in order to send information. In other words, communication devices share information via only one-to-one communication.

Accordingly, devices in a conventional communication system may often have difficulties in establishing a close relationship for sharing information with each other. Particularly, a user's handling should take precedence in order for each device to select and access a desired other device. Furthermore, in cases where a device sends information to a selected device where another device wants to transmit information to the sending device, a user's input is required to stop transmission of information to the former device as well as to select the latter device. Unfortunately, this causes inconvenience to end users of communication devices.

### SUMMARY OF THE INVENTION

The present invention is designed to address at least some the above-mentioned problems and/or disadvantages and to provide at least the advantages described below.

According to an aspect of the present invention, a multi-device control method for communication devices is provided. The method includes sharing particular information with a serving device after accessing the serving device through a communication channel; measuring signal strength of each of slave devices using the communication channel, the slave devices including the serving device; selecting one of the slave devices as a target device with relatively greater signal strength; and transmitting the information to the target device through the communication channel.

According to another aspect of the present invention, provided is a multi-device control apparatus of a communication device. The apparatus includes: a communication unit configured to transmit and receive information through a communication channel in order to share the information with a serving device accessed through the communication channel, the serving device being one of the slave devices; a detection unit configured to measure signal strength of each slave device using the communication channel; and a control unit configured to select one of the slave devices as a target device with relatively greater signal strength, and to transmit the information to the target device through the communication channel.

### BRIEF DESCRIPTION OF THE DRAWINGS

Other aspects, advantages, and salient features of the invention will become apparent to those skilled in the art from the following detailed description, when taken in conjunction with the annexed drawings, in which:

FIG. 1 is a schematic view illustrating a communication system in accordance with an embodiment of the present invention;

FIG. 2 is a schematic view illustrating a flow of information among devices in the communication system illustrated in FIG. 1;

FIG. 3 is another schematic view illustrating a flow of information among devices in the communication system illustrated in FIG. 1;

FIG. 4 is a block diagram illustrating a communication device in accordance with an embodiment of the present invention;

FIG. 5 is a flow diagram illustrating a multi-device control method in accordance with an embodiment of the present invention;

FIG. 6 is a flow diagram illustrating a detailed process of operating as a master device in the multi-device control method shown in FIG. 5;

FIG. 7 is a flow diagram illustrating a detailed process of operating as a slave device in the multi-device control method shown in FIG. 5;

FIG. 8 illustrates a superframe structure used in the multi-device control method shown in FIG. 5; and

FIG. 9 illustrates a superframe structure used in the multi-device control method shown in FIG. 5.

### DETAILED DESCRIPTION OF EMBODIMENTS OF THE INVENTION

Various embodiments of the present invention will now be described more fully with reference to the accompanying drawings. This invention may, however, be embodied in many different forms and should not be construed as limited to the exemplary embodiments set forth herein. The principles and features of this invention may be employed in varied and numerous embodiments without departing from the scope of the invention.

Furthermore, well known or widely used techniques, elements, structures, and processes may not be described or illustrated in detail to avoid obscuring the essence of the present invention. Although the drawings represent exemplary embodiments of the invention, the drawings are not necessarily to scale and certain features may be exaggerated or omitted in order to better illustrate and explain the present invention.

Among terms set forth herein, the term ‘information’ refers to data that is stored in advance in any communication device and is ready for sharing with other communication devices. Information may include packet data such as image data, text data and audio data. For example, information may be provided in the form of electronic books, movies, music, and the like.

The term ‘master device’ refers to a specific communication device which is capable of controlling at least one communication device in a given communication system. Specifically, a master device selects a device and then transmits or receives information to or from the selected device. The term ‘slave device’ refers to communication devices controlled by a master device in a given communication system. Specifically, each individual slave device transmits or receives information to or from a master device, depending on the selection of the master device. The term ‘serving device’ refers to a specific slave device currently controlled by a master device. The term ‘target device’ refers to other specific slave devices to be controlled by a master device. Namely, a master device can change an object of control from a serving device to a target device.

The term ‘signal strength’ refers to the power of a signal received from slave devices by a master device in a communication system. Typically, signal strength may be a Received Signal Strength Indication (RSSI) or a physical distance between a master device and a slave device.

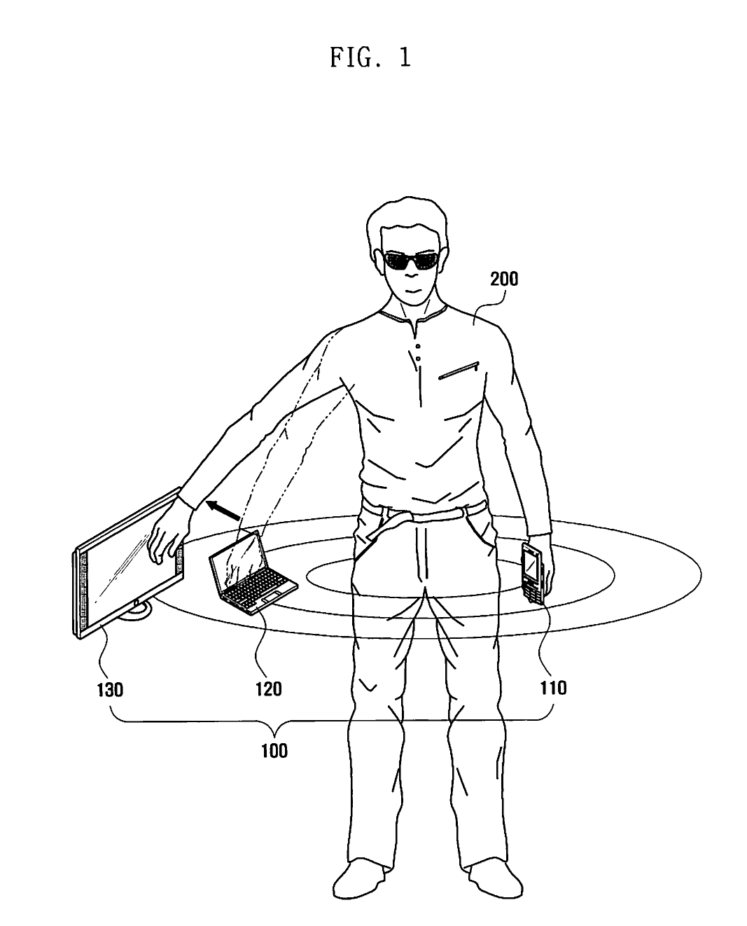

FIG. 1 is a schematic view illustrating a communication system in accordance with an embodiment of the present invention.

Referring to FIG. 1, the communication system in this embodiment allows transmission and reception of signals through the Electric Field Communication (EFC) such as the human body communication. Such a communication system is composed of a plurality of communication devices 100, including, 110, 120 and 130, and a human body 200.

Each of the communication devices 100 (110, 120 and 130) may send and receive signals by using the human body 200 as a communication channel. When any communication device 100 receives a signal, the human body 200 generates the electric field through which a signal is delivered to any other communication device 100. A mobile phone, a Personal Digital Assistant (PDA), a smart phone, a Portable Multimedia Player (PMP), an MP3 player, an electronic notebook, a personal computer, a TV, and many other kinds of electronic devices may be used for the communication device 100. As a living organism, the human body 200 allows for the creation of the electric field.

Signal strength may rely on a distance between each communication device 100 and the human body 200. Specifically, signal strength is relatively high as the communication device 100 is close to the human body 200. On the contrary, signal strength is relatively low as the communication device 100 is distant from the human body 200. Therefore, when the communication device 100 is in contact with or adjacent to the human body 200, it may more reliably transmit and receive signals. Since normally the human body 200 does not remain stationary, communication devices 100 capable of communicating with a specific communication device may vary according to time. Individual communication devices 100 may act as a master device or a slave device. Also, each slave device may act as a serving device or a target device.

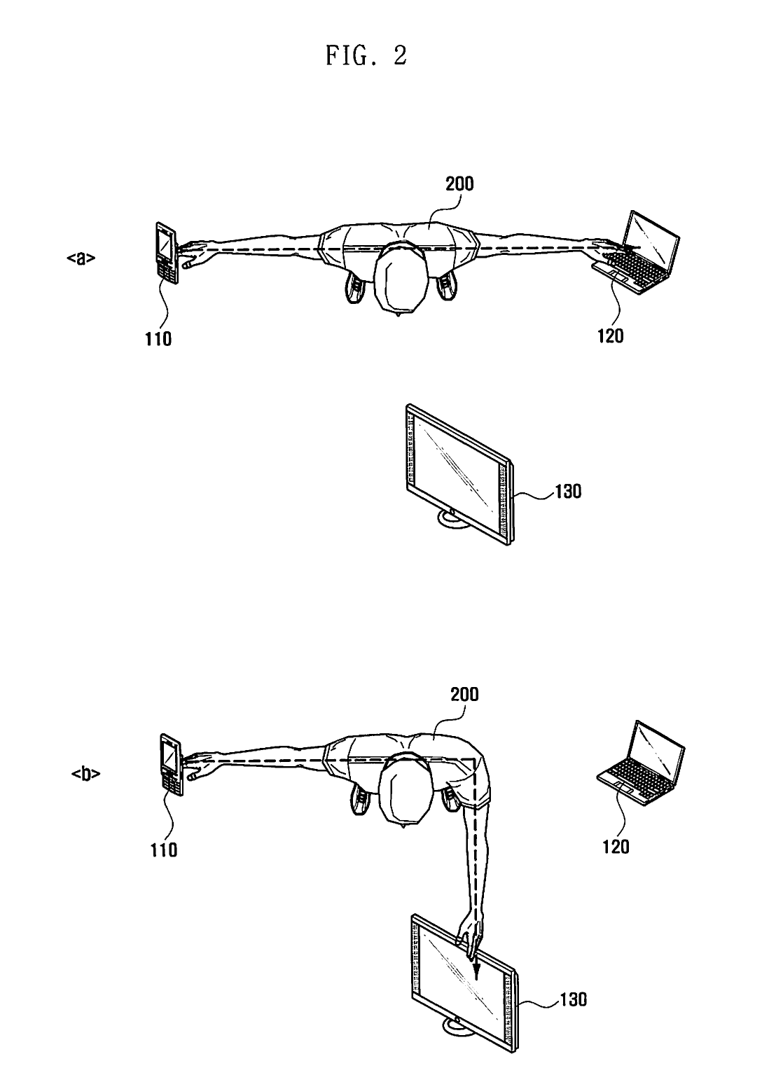

FIG. 2 is a schematic view illustrating a flow of information among devices in the communication system shown in FIG. 1. In this embodiment, device 110 will be considered to be a master device, and the others 120 and 130 to be slave devices. Furthermore, one slave device 120 will be considered to be a serving device, and the other 130 to be a target device.

Referring to FIG. 2, in one case, information is transmitted from the master device 110 to the slave devices 120 and 130.

Specifically, the master device 110 measures the signal strength of the respective slave devices 120 and 130 using the human body 200 as a communication channel. Then the master device 110 selects one of the slave devices 120 and 130, depending on the measured signal strength, and transmits information to the selected slave device.

In a situation illustrated in part (a) in FIG. 2, the first slave device 120 is closer to the human body 200 than the second slave device 130, so the signal strength of the first slave device 120 may be greater than that of the second slave device 130. Therefore, the master device 110 selects the first slave device 120 as a serving device and sends information.

Meanwhile, in the situation illustrated in part (b) in FIG. 2, the second slave device 130 is closer to the human body 200 than the first slave device 120, so the second slave device 130 may have greater signal strength than the first slave device 120. Therefore, the master device 110 selects the second slave device 130 as a target device, stops transmission of information to the serving device 120, and sends information to the target device 130.

Information transmitted to the slave devices 120 and 130 by the master device 110 may be stored in advance in the master device 110. Alternatively, the master device 110 may receive information from wired or wireless communication networks and offer such information to the slave devices 120 and 130. In addition, the master device 110 may divide information between the serving device 120 and the target device 130. For instance, after sending half of information to the serving device 120, the master device 110 may transmit the other half to the target device 130. Alternatively, the master device 110 may offer the same information to the serving device 120 and the target device 130. Specifically, even though the serving device 120 fails to receive the entire information, the master device 110 may transmit information to the target device 130 at the beginning.

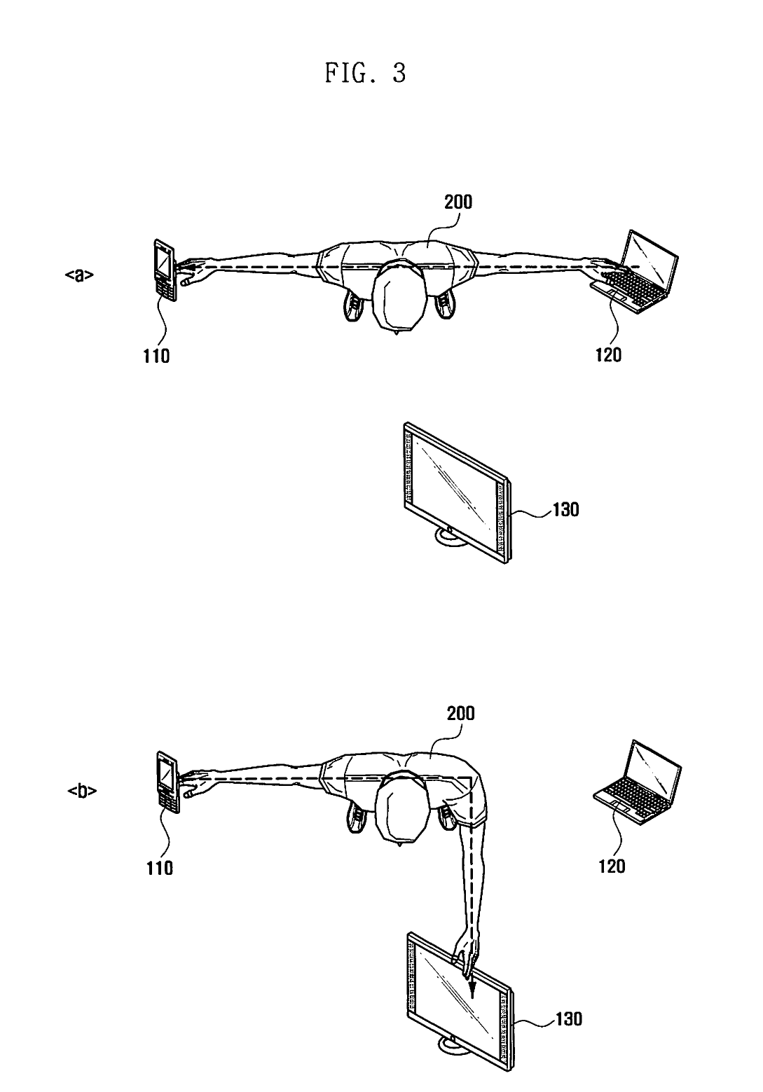

FIG. 3 is another schematic view illustrating a flow of information among devices in the communication system illustrated in FIG. 1.

Referring to FIG. 3, in another case, information is transmitted between the slave devices 120 and 130 via the master device 110.

The master device 110 measures the signal strength of the respective slave devices 120 and 130 using the human body 200 as a communication channel. Then the master device 110 selects one of the slave devices 120 and 130, depending on the measured signal strength, and receives information from the selected slave device.

In a situation illustrated in part (a) in FIG. 3, the master device 110 selects the first slave device 120 with greater signal strength as a serving device and then receives information from the serving device 120. Meanwhile, if the signal strength of the second slave device 130 becomes greater than that of the first slave device 120 as illustrated in part (b) in FIG. 3, the master device 110 selects the second slave device 130 as a target device and sends information to the target device 130.

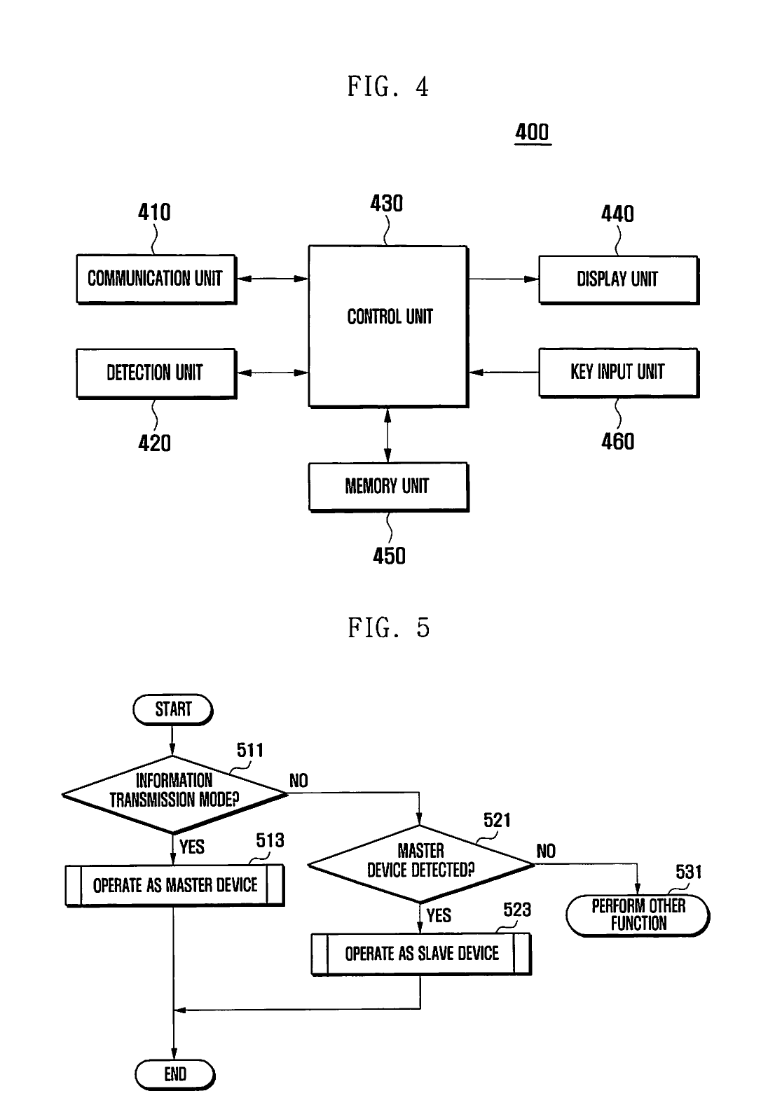

FIG. 4 is a block diagram illustrating a communication device in accordance with an exemplary embodiment of the present invention.

Referring to FIG. 4, the communication device 400 in this embodiment includes a communication unit 410, a detection unit 420, a control unit 430, a display unit 440, a memory unit 450, and a key input unit 460.

The communication unit 410 performs a function of processing transmitted and received signals. Typically, the communication unit 410 includes a transmitter which upwardly converts the frequency of signals to be transmitted and amplifies the signals, and a receiver which amplifies received signals with low-noise and downwardly converts the frequency of the received signals. In an embodiment of this invention, the communication unit 410 transmits and receives a signal through the electric field of the human body 200. This communication unit 410 may form a closed loop through the air ground or the earth ground.

The detection unit 420 performs a function of detecting the signal strength present in a signal received through the human body 200. In an embodiment of the present invention, the detection unit 420 detects signal strength of other communication devices located within a given distance. Also, the detection unit 420 may periodically detect signal strength and hence determine a variation in signal strength.

The control unit 430 performs a function of controlling the operations of the communication device 400. The control unit 430 includes a data processing unit composed of a transmitter for encoding and modulating signals to be transmitted and a receiver for demodulating and decoding received signals. Here, the data processing unit may have a modem and a codec. Also, the codec has a data codec for processing packet data and an audio codec for processing audio signals. Particularly, the control unit 430 performs a role of a master device in an information transmission mode for sharing information with other devices. Specifically, the control unit 430 searches slave devices within a predefined communication range. Then the control unit 430 selects a specific slave device with relatively greater signal strength as a serving device. Also, when signal strength is varied after selection of a serving device, the control unit 430 selects another slave device with relatively greater signal strength as a target device.

Alternatively, the control unit 430 may perform a role of a slave device when a master device is detected within a predefined communication range.

The display unit 440 represents on a screen a variety of information outputted from the control unit 430. The display unit 440 may be formed of a Liquid Crystal Display (LCD) or any other equivalents. Also, the display unit 440 may employ a touch screen that also performs a role of an input unit.

The memory unit 450 may be composed of a program region and a data region. The program region stores a variety of programs required for controlling a general operation of the communication device 400. In an embodiment of this invention, the program region may store a specific program used for sharing information in a communication system. The data region stores data created while such programs are running.

The key input unit 460 includes a plurality of normal alphanumeric keys and some special function keys. Touch-based input keys or any other various input manners may be used alternatively or additionally.

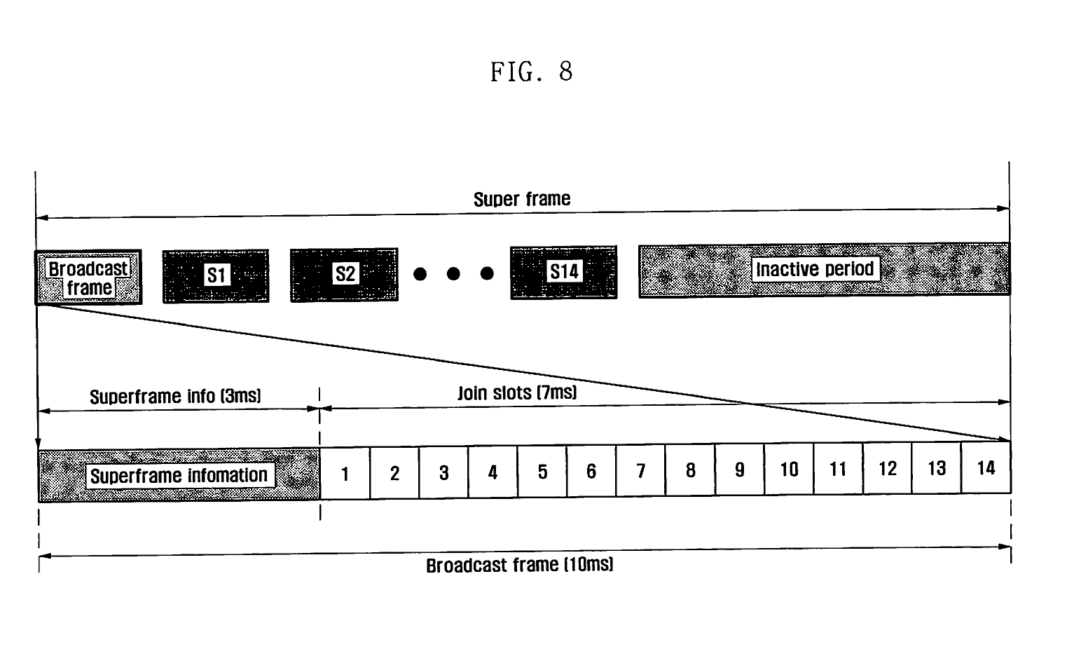

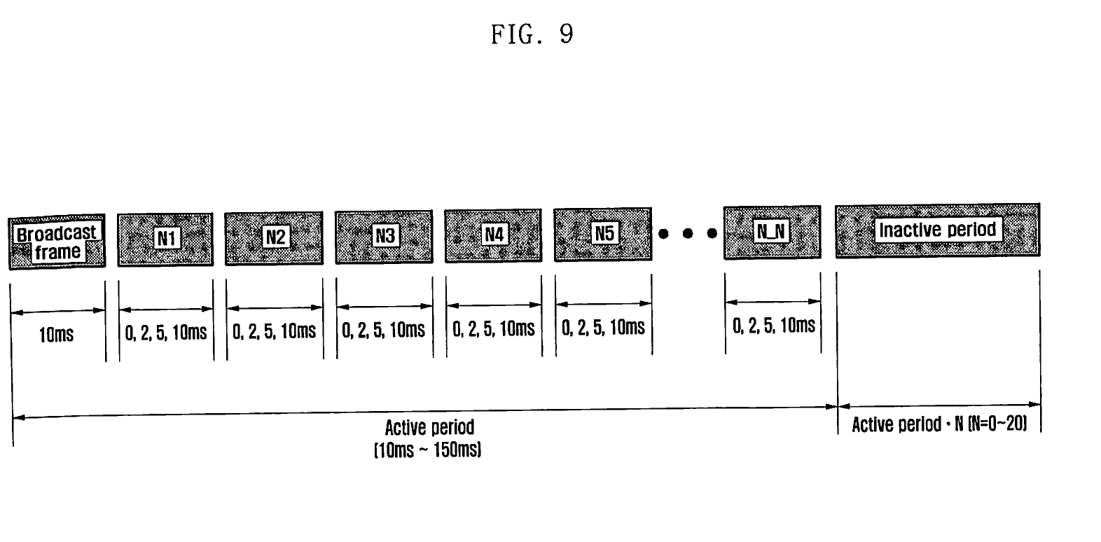

FIG. 5 is a flow diagram illustrating a multi-device control method in accordance with an embodiment of the present invention. In addition, FIG. 8 is an example illustrating a superframe structure used in the multi-device control method shown in FIG. 5, and FIG. 9 is another example illustrating a superframe structure used in the multi-device control method shown in FIG. 5. Specifically, FIGS. 8 and 9 show superframe structures for a human body communication.

Referring to FIG. 5, at the outset, the control unit 430 determines whether an information transmission mode is enabled in step 511, and then operates as a master device in step 513. Specifically, the control unit 430 searches slave devices within a predefined communication range. Then the control unit 430 selects a specific slave device and shares information with a selected device. Namely, the control unit 430 may request or transmit information to a selected slave device.

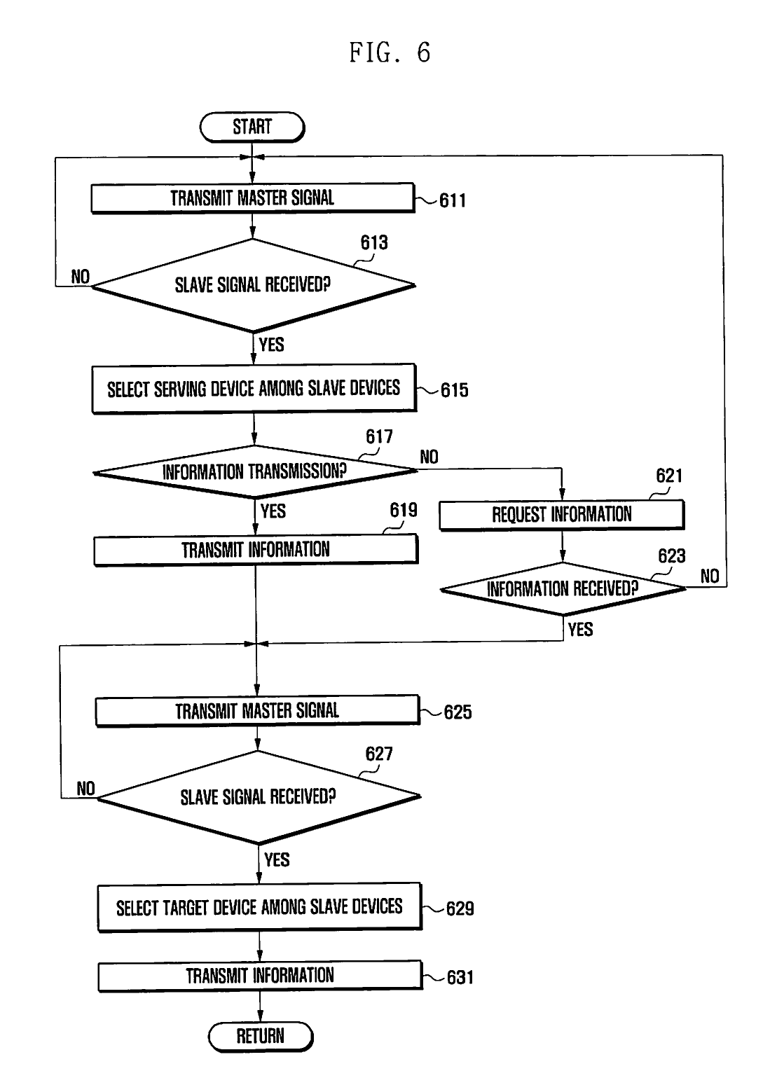

FIG. 6 is a flow diagram illustrating a detailed process of operating as a master device in the multi-device control method shown in FIG. 5.

Referring to FIG. 6, in case of operating as a master device, the control unit 430 sends a master signal in step 611. Here, a master signal is used to search slave devices within a predefined communication range. As shown in FIGS. 8 and 9, the control unit 430 transmits a master signal in a broadcast frame by using a human body as a channel. Specifically, a master signal is delivered to surrounding regions near a human body through a human body.

Then the control unit 430 determines whether a slave signal is received in response to a master signal in step 613. If a slave signal is received from at least one slave device, the control unit 430 selects a specific slave device with relatively greater signal strength as a serving device in step 615. Here, a slave signal is a particular signal in response to a master signal. The control unit 430 may receive such a slave signal delivered through the human body 200. For instance, the control unit 430 may receive a slave signal through at least one of intervals S1 to S14 in a superframe as shown in FIGS. 8 and 9. That is, when receiving such a slave signal, the control unit 430 recognizes that at least one slave device exists within a predefined communication range. Then the control unit 430 detects signal strength present in each slave signal, compares it with each other, and selects a serving device.

If any slave signal is not received in step 613, the control unit 430 performs step 611 again. The control unit 430 may transmit a master signal under specific conditions, e.g., periodically, in step 611 until any slave signal is received in step 613. Namely, as shown in FIGS. 8 and 9, the control unit 430 may send a master signal in a broadcast frame of each superframe.

Next, the control unit 430 determines whether to transmit information to a serving device in step 617. At this time, the control unit 430 may determine whether an information transmission mode enabled in step 511 is a mode for sending information to a serving device. Meanwhile, when enabling an information transmission mode in step 511, the control unit 430 may predetermine whether to transmit information to a serving device.

If it is determined in step 617 that information should be transmitted to a serving device, the control unit 430 performs transmission of information to a serving device in step 619. Meanwhile, when predetermining whether to transmit information to a serving device, as discussed above, the control unit 430 may further predetermine which information is to be transmitted to a serving device. Here, the control unit 430 may send information stored in the memory unit 450 or alternatively send information received from wired or wireless communication networks.

If no transmission information is determined in step 617, the control unit 430 requests a serving device to offer information in step 621. Meanwhile, when predetermining whether to transmit information to a serving device, as discussed above, the control unit 430 may further predetermine which information is to be requested from a serving device. Then the control unit 430 determines whether any information is received from a serving device in step 623.

While transmitting information to a serving device in step 619 or after receiving information from a serving device in step 623, the control unit 430 transmits again a master signal in step 625. Here, the control unit 430 transmits a master signal in a broadcast frame by using a human body as a channel, as shown in FIGS. 8 and 9. Specifically, a master signal is delivered to surrounding regions near a human body through a human body.

Then the control unit 430 determines whether a slave signal is received in response to a master signal in step 627. If a slave signal is received from at least one slave device, the control unit 430 selects a specific slave device with relatively greater signal strength as a target device in step 629. Here, the control unit 430 may receive such a slave signal delivered through the human body 200. For instance, the control unit 430 may receive a slave signal through at least one of intervals S1 to S14 in a superframe, as shown in FIGS. 8 and 9. That is, when receiving such a slave signal, the control unit 430 recognizes that at least one slave device exists within a predefined communication range. Then the control unit 430 detects signal strength present in each slave signal, compares it with each other, and selects a target device.

If any slave signal is not received in step 627, the control unit 430 performs again step 625. The control unit 430 may transmit a master signal under specific conditions, e.g., periodically, in step 625 until any slave signal is received in step 627. As shown in FIGS. 8 and 9, the control unit 430 may send a master signal in a broadcast frame of each superframe.

Finally, the control unit 430 transmits information to a target device in step 631 and returns to a process shown in FIG. 5. At this time, the control unit 430 may send at least a part of information to a target device after stopping transmission of information to a serving device. Here, the control unit 430 may transmit continuously at least a part of information next to a transmitted part, to a target device. Alternatively, the control unit 430 may transmit the same information to a target device at the beginning.

Returning to FIG. 5, if an information transmission mode is not enabled in step 511, the control unit 430 further determines whether a master device is detected in step 521, and then operates as a slave device in step 523. Therefore, the control unit 430 may share information with a master device. Namely, the control unit 430 may receive or transmit information from or to a master device. The control unit 430 may operate as a serving device or a target device.

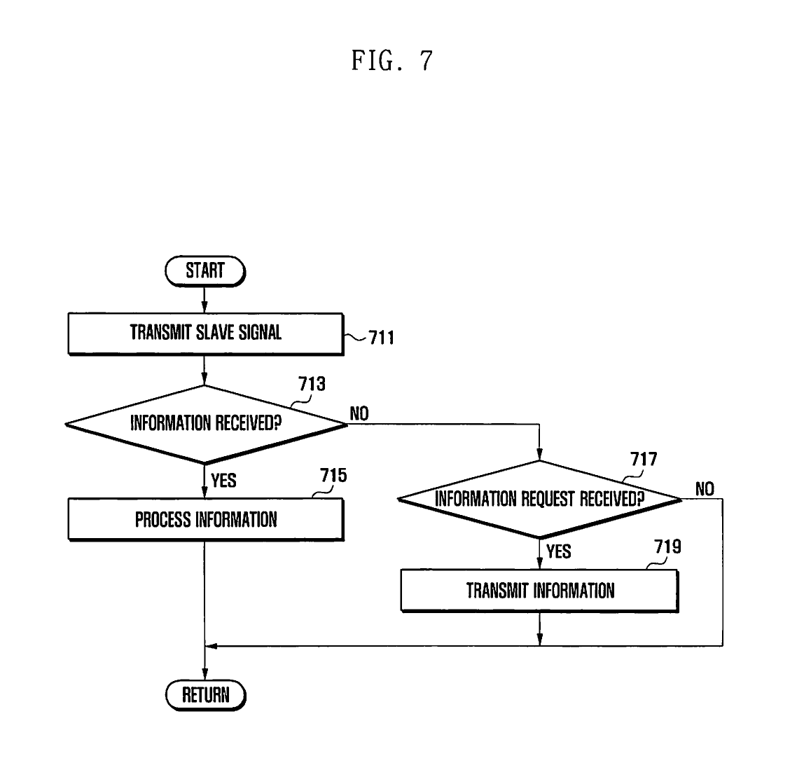

FIG. 7 is a flow diagram illustrating a detailed process of operating as a slave device in the multi-device control method shown in FIG. 5.

Referring to FIG. 7, in case of operating as a slave device, the control unit 430 sends a slave signal in response to a master signal in step 711. Here, the control unit 430 detects a master device by receiving a master signal in a broadcast frame as shown in FIGS. 8 and 9. Namely, the control unit 430 recognizes that a master device exists within a predefined communication range. Then the control unit 430 sends a slave signal in response to a master signal through at least one of intervals S1 to S14 in a superframe as shown in FIGS. 8 and 9.

After sending a slave signal, the control unit 430 determines whether information is received from a master device in step 713. If there is information received, the control unit 430 processes received information in step 715 and returns to a process shown in FIG. 5. Here, the control unit 430 may save or output processed information.

If any information is not received in step 713, the control unit 430 further determines whether a request for information is received from a master device in step 717. If information is requested, the control unit 430 performs transmission of information to a master device in step 719 and returns to a process shown in FIG. 5. Here, the control unit 430 retrieves information requested by a master device and offers it to a master device.

Returning to FIG. 5, if a master device is not detected in step 521, the control unit 430 performs any other function in step 531. Specifically, the control unit 430 may operate independently without operating as one of a master device and a slave device.

Although a human body is used for communications between devices in the above-discussed embodiment, this is an example only and not to be considered as a limitation of the present invention. Alternatively, the present invention may be favorably applied to another communication apparatus that employs a radio frequency unit as the aforesaid communication unit and also uses a proximity sensor unit as the aforesaid detection unit. In case of this apparatus, a slave device may detect a master device and then measure signal strength of a detected master device by using a proximity sensor unit. A master device may determine a serving device or a target device by receiving signal strength from a slave device. Here, a master device and a slave device may be communicated through wireless environments.

Additionally, the present invention may be favorably applied to still another communication apparatus, which employs a motion sensor unit instead of a proximity sensor unit. Specifically, a slave device may use a motion sensor unit to detect a master device and to measure signal strength of a detected master device. Then a slave device offers signal strength to a master device, which may determine a serving device or a target device by using received signal strength. A master device and a slave device may be communicated through wireless environments.

As discussed hereinbefore, in a communication system according to this invention, a communication device may selectively control any other communication devices, depending on their signal strength. A communication device transmitting information does not require a user's handling for selecting a destination device. Furthermore, in case where a communication device wants to change destination devices, such a device does not require a user's handling for stopping a current transmission of information and for selecting a new destination device. Therefore, a communication device may simply control any other devices without needing a user's handling. This may enhance a user's convenience, while favorably allowing respective devices to establish a close relationship for sharing information with each other in a communication system.

While the present invention has been particularly shown and described with reference to certain embodiments thereof, it will be understood by those skilled in the art that various changes in form and details may be made therein without departing from the spirit and scope of the present invention as defined by the appended claims.

What is claimed is:

1. A multi-device control method for communication devices, the method comprising:
sharing particular information with a serving device after accessing the serving device through a communication channel;
measuring signal strength of at least one slave device using the communication channel, the slave devices including the serving device;
selecting one of the slave devices having greater signal strength as a target device; and
transmitting the information to the target device through the communication channel.

2. The method of claim 1, wherein sharing of the information includes:
detecting the signal strength of each slave device while operating as a master device in an information transmission mode; and
transmitting the information to the serving device after selecting one of the slave devices as the serving device with relatively greater signal strength.

3. The method of claim 1, wherein sharing of the information includes:
detecting the signal strength of each slave device while operating as a master device in an information transmission mode;
sending a request for the information to the serving device after selecting one of the slave devices as the serving device with relatively greater signal strength; and
receiving the information from the serving device.

4. The method of claim 1, wherein the communication channel includes a human body.

5. The method of claim 4, wherein measuring of the signal strength includes:
transmitting a master signal for searching the slave devices to the human body;
receiving a slave signal from each slave device in response to the master signal through the human body; and
interpreting strength of the slave signal as the signal strength.

6. The method of claim 4, further comprising:
transmitting a slave signal in response to a master signal received from a master device while operating as a slave device;
receiving different information from the master device; and
processing the different information.

7. The method of claim 4, further comprising:
transmitting a slave signal in response to a master signal received from a master device while operating as a slave device;
receiving a request for different information from the master device; and
transmitting the different information to the master device.

8. A multi-device control apparatus of a communication device, the apparatus comprising:
a communication unit configured to transmit and receive information through a communication channel in order to share the information with a serving device accessed through the communication channel, the serving device being at least one slave device;
a detection unit configured to measure signal strength of each slave device using the communication channel; and
a control unit configured to select one of the slave devices as a target device with relatively greater signal strength, and to transmit the information to the target device through the communication channel.

9. The apparatus of claim 8, wherein the control unit is further configured to detect the signal strength of each slave device while operating as a master device in an information transmission mode, and to transmit the information to the serving device after selecting one of the slave devices as the serving device with relatively greater signal strength.

10. The apparatus of claim 8, wherein the control unit is further configured to detect the signal strength of each slave device while operating as a master device in an information transmission mode, to send a request for the information to the serving device after selecting one of the slave devices as the serving device with relatively greater signal strength, and to receive the information from the serving device.

11. The apparatus of claim 8, wherein the communication channel includes a human body.

12. The apparatus of claim 11, wherein the control unit is further configured to transmit a master signal for searching the slave devices to the human body, to receive a slave signal from each slave device in response to the master signal through the human body, and to interpret strength of the slave signal as the signal strength.

13. The apparatus of claim 11, wherein the control unit is further configured to transmit a slave signal in response to a master signal received from a master device while operating as a slave device, to receive different information from the master device, and to process the different information.

14. The apparatus of claim 11, wherein the control unit is further configured to transmit a slave signal in response to a master signal received from a master device while operating as a slave device, to receive a request for different information from the master device, and to transmit the different information to the master device.
